(19) United States
(12) Patent Application Publication
(10) Pub. No.: US 2025/0042131 A1
(43) Pub. Date: Feb. 6, 2025

(54) MULTIFUNCTIONAL PROTECTIVE COATING SYSTEM FOR COSMETIC AND HYGIENE PRODUCTS

(71) Applicant: Charles Fredrick Mackenbach, Rolling Hills, CA (US)

(72) Inventor: Charles Fredrick Mackenbach, Rolling Hills, CA (US)

(21) Appl. No.: 18/788,950

(22) Filed: Jul. 30, 2024

Related U.S. Application Data
(60) Provisional application No. 63/529,934, filed on Jul. 31, 2023.

(51) Int. Cl. B32B 7/06

(52) U.S. Cl. CPC B32B 7/06; B32B 2555/00

(57) ABSTRACT

A protective coating system for solid cosmetic and hygiene products comprises a removable, water-resistant coating that encapsulates the product while leaving at least one face exposed for use. The system includes multiple coating removal mechanisms: a self-regulating material designed to degrade synchronously with product use, an embedded cord system for manual removal, and a mechanical removal device integrated into a complementary cap. A base protection system provides additional functionality, allowing for the attachment of accessories. The coating protects the product from premature degradation, improves grip, and allows for controlled product use. This system extends product lifespan, enhances user experience, and provides an environmentally friendly alternative to excessive packaging. The versatility of the coating removal options accommodates various product types and user preferences, ensuring the benefits of the coating can be realized across a wide range of applications.

### RELATED APPLICATIONS

This application claims the benefit of the U.S. Provisional Application No. 63/529,934, filed 07, 31, 2023, the entire contents of which are hereby incorporated by reference.

### FIELD OF THE INVENTION

The present invention relates to the field of personal care and hygiene products, particularly to solid form products such as soap bars, shampoo bars, conditioner bars, deodorants, hand soap and other solid consumables designed to be used with water. More specifically, the invention pertains to a protective coating system that enhances the longevity, functionality, and user experience of these products.

### BACKGROUND OF THE INVENTION

Solid form personal care products offer advantages in terms of reduced packaging waste and convenience. However, they often suffer from rapid degradation due to exposure to moisture and air, leading to reduced lifespan and diminished user experience.

Traditional liquid personal care products, such as shampoos, body washes, and conditioners, are typically packaged in plastic bottles with dispensing mechanisms. While functional, these packaging systems create significant environmental issues due to plastic waste. The high water content in these formulations (typically around 80-95% by weight) necessitates large containers, contributing to increased packaging waste and transportation inefficiencies.

In response to growing environmental concerns and regulations pressuring a shift away from plastics, solid bar forms of these products have gained popularity. However, these solid bar solutions face several functional challenges: 1. Slipperiness: Soap bars and other solid products used with water are inherently slippery when wet, leading to frequent dropping during use. 2. Water absorption: These bars tend to absorb water and degrade when exposed to moisture, becoming soft, mushy, and unpleasant to use. 3. Rapid degradation: As all surfaces of these bars are exposed to water, they degrade much faster than if only the face in contact with the user were to degrade, resulting in significant product waste. 4. Perceived hygiene issues: Many users consider bar products unhygienic, particularly when shared, due to the potential transfer of contaminants.

Various attempts have been made to address these issues, including: 1. Soap dishes and trays: Designed with drainage features to remove excess water from the product. While these can help reduce water absorption, they do not address the issue of degradation during use or slipperiness. 2. Ergonomic bar shapes: Products designed with ridges, curves, or unusual shapes to enhance grip. However, these designs often compromise the product's efficiency and do not solve the core issues of degradation and hygiene concerns. 3. Formulation adjustments: Attempts to create more water-resistant formulations. These often result in reduced lathering or cleaning efficacy, compromising the product's primary function.

While these solutions offer partial remedies, they often compromise the user experience, add significant cost to the product, or fail to comprehensively address all the challenges faced by solid personal care products.

There remains a need for a solution that can extend the life of solid personal care products, enhance their functionality, and improve the overall user experience without significantly increasing production costs or compromising the product's eco-friendly nature. Such a solution should ideally address the issues of slipperiness, water absorption, rapid degradation, and hygiene concerns in a unified, cost-effective manner.

### SUMMARY OF THE INVENTION

The present invention addresses the aforementioned needs by providing a multifunctional protective coating system for solid cosmetic and hygiene products. This system comprises a removable, water-resistant coating that encapsulates the product, wherein the product has at least one face, and the coating leaves at least one face of the product exposed for use.

In one aspect, the invention provides a cosmetic product comprising: a) a cosmetic or hygiene formulation shaped into a predetermined form; b) a removable, water-resistant coating encapsulating at least a portion of the formulation, wherein at least one face of the formulation remains uncoated.

The coating is designed to be removed and to expose a portion of the underlying product through various methods, each offering unique benefits: a) Self-regulating degradation: The coating is engineered to degrade synchronously with product use, automatically exposing fresh product as needed. b) Mechanical removal: A device or tool can be used to separate and peel away sections of the coating, allowing for more controlled exposure of the product. c) Embedded cord system: Cords integrated into the coating can be pulled to remove specific sections, providing precise control over product exposure.

The invention also provides a method for using this coated cosmetic product, comprising: a) providing a cosmetic product with the protective coating; b) exposing a portion of the product for use; c) using the exposed portion of the product; d) removing a section of the coating using one of the aforementioned methods to expose a fresh portion of the product.

The coating material may consist of various water-resistant substances, formulated to achieve the desired removal characteristics including but not limited to: a) Natural waxes such as beeswax, carnauba wax, candelilla wax, or rice bran wax; b) Synthetic waxes like polyethylene wax, Fischer-Tropsch wax, or microcrystalline wax; c) Biodegradable polymers such as polylactic acid (PLA), polyhydroxyalkanoates (PHA), or polybutylene succinate (PBS); d) Water-resistant biopolymers like chitosan or zein; e) Hydrophobic silica-based materials; f) Fluoropolymers such as polytetrafluoroethylene (PTFE) or fluorinated ethylene propylene (FEP);

In another aspect, the protective coating system enables the integration of additional components such as a base, cap, and various accessories. This capability significantly enhances the product's functionality, protection, and user experience. The coating allows for the secure attachment of a base, which can serve as a mounting point for accessories like protective caps, application tools, or product-specific implements. This modular approach expands the utility of the solid cosmetic product beyond its basic function, offering users a more versatile and comprehensive personal care solution.

These aspects of the invention work in concert to provide a comprehensive solution that extends product life, enhances functionality, and improves user experience while addressing the environmental concerns associated with traditional packaging methods.

### DESCRIPTION OF THE DRAWINGS

Referring to FIG. 1a, a perspective view of a wax-coated solid cosmetic product is shown in accordance with one embodiment of the present invention, which utilizes the self-regulating coating removal process. The product comprises a wax coating (100) encapsulating a solid cosmetic formulation (200), with the top face of the formulation remaining exposed for use. This configuration allows for immediate use of the product while providing protection to the majority of the formulation. The self-regulating nature of the coating is achieved through its carefully calibrated composition and physical properties. As the exposed face of the formulation is used and wears away, the adjacent coating loses structural support. This loss of support, combined with the coating's engineered brittleness and adhesion properties, causes sections of the coating to break away, revealing fresh product underneath. This process enables the coating to degrade synchronously with the use of the product, maintaining the protective function throughout the product's lifespan. The detailed mechanisms of this self-regulating process will be described in more detail in the detailed description section.

FIG. 1b presents a cross-sectional view of the wax-coated solid cosmetic product shown in FIG. 1a, clearly depicting the relationship between the coating (100) and the solid cosmetic formulation (200). This view highlights the exposed top face of the formulation, demonstrating how the product can be used while maintaining protection for the bulk of the formulation. The cross-section also illustrates how the self-regulating coating is designed to wear away gradually as the exposed face of the product is used.

FIG. 1c offers a perspective view similar to FIG. 1a, but with the solid cosmetic formulation (200) shown in dashed lines to emphasize its position within the coating (100). This visualization depicts the internal structure of the product, illustrating how the coating envelops the formulation while leaving one face exposed. The dashed lines also help to conceptualize how the self-regulating coating will recede as the product is used, maintaining a consistent exposed surface area throughout the product's life.

Moving to FIG. 2a, an exploded perspective view is presented, showing a base component (300) and an uncoated solid cosmetic formulation (200). This view demonstrates the assembly process prior to the application of the wax coating, illustrating how a base and formulation fit together to increase the functionality of the coating application. In this case the base is a cup-like structure designed to attach to the bottom of the formulation prior to coating, providing crucial protection to this vulnerable area while also creating opportunities for additional functionality such as mounting mechanisms and accessories.

FIG. 2b provides a cross-sectional view of the solid product and base prior to attachment. This view shows the base (300) and the solid formation positioned above it, illustrating the spatial relationships between these components and how they are designed to connect prior to binding them via a press or insertion operation.

FIG. 2c presents a cross-sectional view of the assembled product, showing the base (300) and solid cosmetic formulation (200) prior to having the wax coating applied. This view demonstrates that the solid cosmetic and base system are securely attached and that the product is ready for the coating application process.

FIG. 2d offers a cross-sectional view of an assembled product, showing the base (300), solid cosmetic formulation (200), and applied wax coating (100). This view illustrates the spatial relationships between these components in the product, demonstrating how the coating protects the formulation while allowing it to remain securely attached to the base.

FIG. 3a presents a perspective view of the prepared product with an attached base and applied coating. Below the product, an example of an accessory that might be mounted to the product using a mounting system is shown. In this case, an accessory cap for travel is depicted, which can be placed on top of the product when not in use to cover the exposed face of the product. The cap features a female slot (401) designed to receive the male tab (301) of the base, locking the two components together. It should be noted that this locking mechanism can be implemented using a variety of different mechanisms such as bayonet mounts, threads, and other snap-fit designs.

FIG. 3b offers a perspective view showing the product preparing to be mounted to the accessory cap, demonstrating how the particular mounting mechanism functions. This view emphasizes the versatility of the design, as the mounting mechanism could be replaced with various other locking/mounting systems to suit different needs or preferences.

FIG. 3c presents a perspective view of the product mated to the aforementioned accessory cap (400), via the base and its locking male tab mechanism (301) inserted into the cap's female slot (401). This illustration clearly shows how the attachment of a base might connect to additional accessories such as the cap shown. It's important to note that other locking mechanisms can be used to attach the base (which has been mounted to the solid product) to a variety of accessories, providing flexibility in design and function.

FIG. 3d provides a cross-sectional view of the fully assembled product system, detailing the spatial relationships between the solid formula (200), wax coating (100), base (300), the base's male mounting tab (301), the accessory cap (400), and the accessory cap's receiving slot (401). This comprehensive view illustrates how all components of the system work together to provide protection, functionality, and convenience.

FIG. 4 presents a series of side by side images depicting the progressive use of the wax-coated solid cosmetic product that is utilizing the self regulating coating mechanism that allows the coating to degrade with the level of formulation use without additional removal mechanisms. FIG. 4A shows a fully prepared product prior to use, with the coating intact and the full volume of the solid formulation. FIG. 4B illustrates a perspective view of a partially used product. The figure demonstrates how the product degrades with use in unison with the self regulating wax coating. The wax coating (100) is supported by the solid cosmetic formulation (200). As the level of the formulation (200) decreases through use, it reaches the level of the coating's lower edge. At this point, the unsupported portion of the coating (100) is removed during normal use of the product, revealing a fresh surface of the formulation (200). FIG. 4C depicts a perspective view of a further degraded product, emphasizing the continued self-regulating nature of the wax coating (100) in relation to the solid formulation (200). This figure clearly illustrates an advanced stage of product use, where a significant portion of both the formulation and coating have been consumed through the self-regulating process.

FIG. 5a presents a perspective view of a wax-coated solid cosmetic product featuring embedded removable cords (102, 103), illustrating an alternative mechanism for controlled wax coating removal. These cords are attached prior to the wax coating process and are thereby underneath the coating. At certain locations, the cords are designed to be removed, providing a user-controlled method of exposing fresh product.

FIG. 5b offers a perspective view similar to FIG. 5A, but with cords (102, 103) partially removed to demonstrate the wax cutting action of the cords. This view shows how the cords can be pulled up from a predetermined location and used to cut through the wax, providing precise control over product exposure.

FIG. 5c presents a perspective view showing a user's hand pulling cord (102), illustrating the user's interaction with the cord removal system. This view emphasizes the ease of use and intuitive nature of this removal method.

FIG. 5d provides a prospective view of the product after complete removal of cord (102), exposing a section of the solid cosmetic formulation (200), while cord (103) remains intact for future use. This view demonstrates the flexibility of the cord system, allowing users to expose as much or as little of the product as needed.

FIG. 6a illustrates a perspective view of the solid product (200) with its exposed face positioned above a modified accessory cap (400) prior to insertion. This accessory demonstrates an alternative wax removal mechanism, distinct from the self-regulating and embedded cord systems previously described. The cap incorporates a mechanical wax removal system featuring a cutting structure (403), not visible in this view. The cutting structure may comprise various blades, edges, or systems designed to separate the wax coating from the solid product.

FIG. 6b presents a side view of the product inserted into the modified accessory cap (400), engaging the wax removal mechanism (403). This cap retains its functionality of covering the exposed portion of the formulation for travel or storage purposes, showcasing the multifunctionality of the accessory system. A wax ejection hole (402) is visible, providing an outlet for the removed wax.

FIG. 6c provides a cut-away view of the accessory cap (400), revealing the internal wax removal mechanism (403). The illustration demonstrates how rotating the mechanism (403) peels away a portion of the coating, exposing more of the encased formulation (200). Removed wax is ejected through hole (402). Alternative embodiments may include a storage chamber for collecting removed wax for later disposal, or mechanisms for adjusting the height of the coating removal.

FIG. 6d depicts a perspective view of the product being inserted into the mechanical removal accessory cap (400), utilizing an affixation tab (301) and female slot (401) mechanism. This illustration demonstrates the ease of mounting and storing the accessory after use.

FIG. 6e presents a side cross-sectional view, expanding upon FIG. 6d, showing the accessory cap (400) in its storage configuration. The illustration emphasizes the accessibility of the separator tool and cap functionality, facilitated by the locking mechanism enabled by the attachment of a base (300) to the coated cosmetic product.

### DETAILED DESCRIPTION OF THE INVENTION

The present invention provides a protective coating system for cosmetic and hygiene products that addresses issues of product degradation, user convenience, and environmental concerns. The invention will be described in detail with reference to various embodiments and the accompanying drawings.

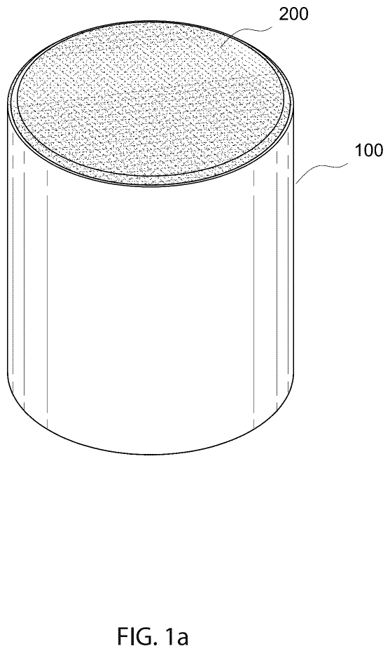

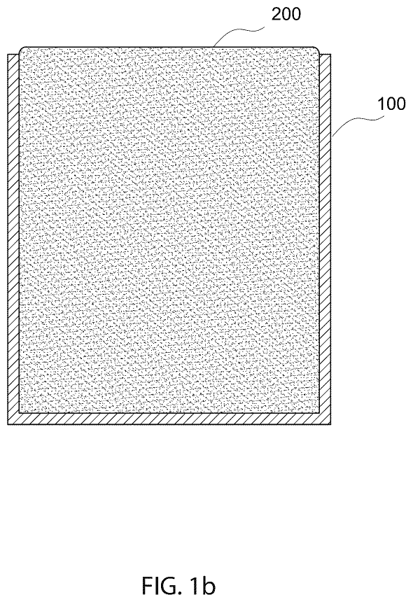

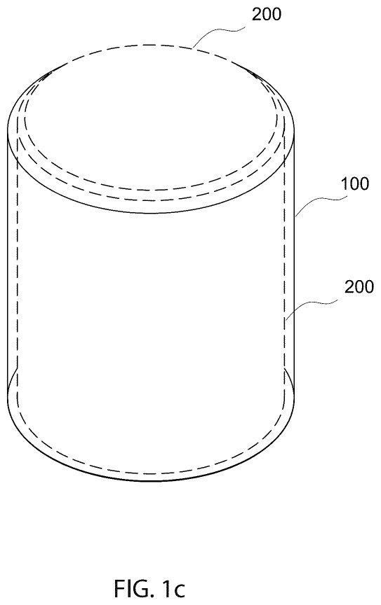

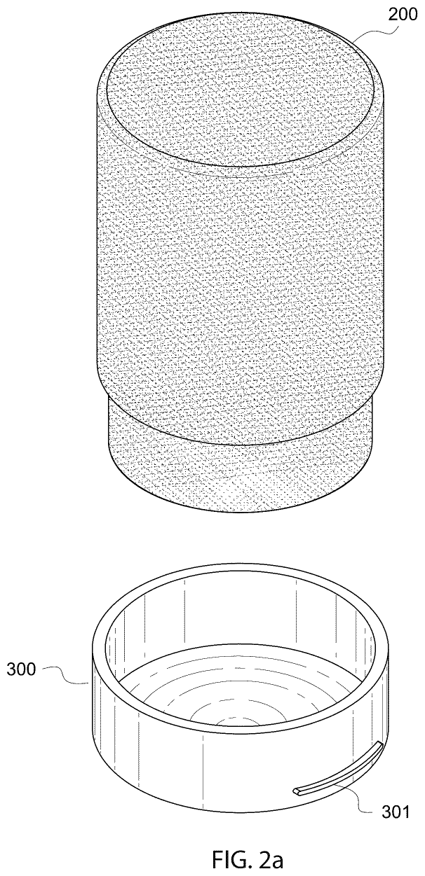

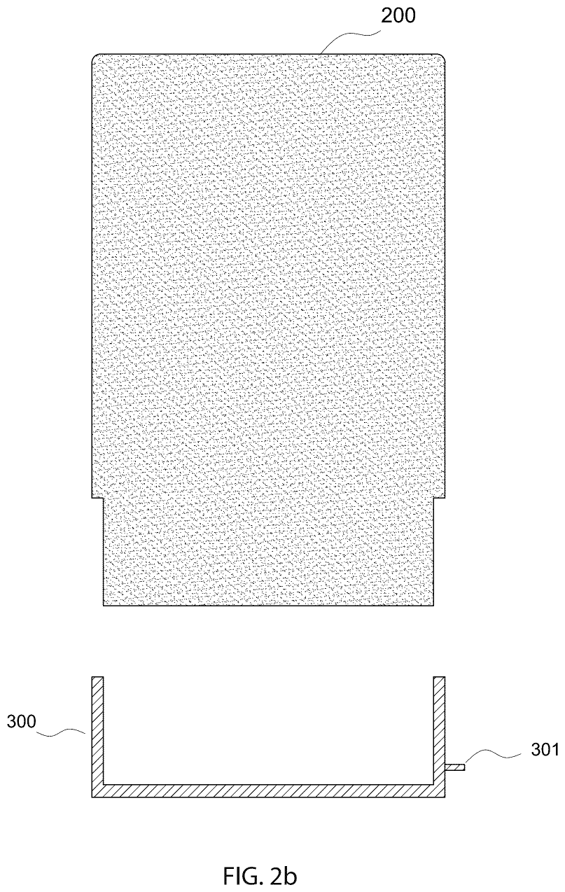

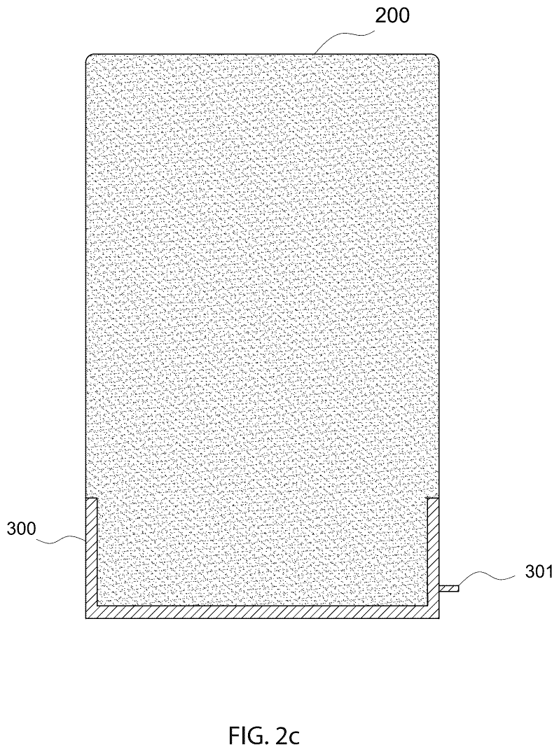

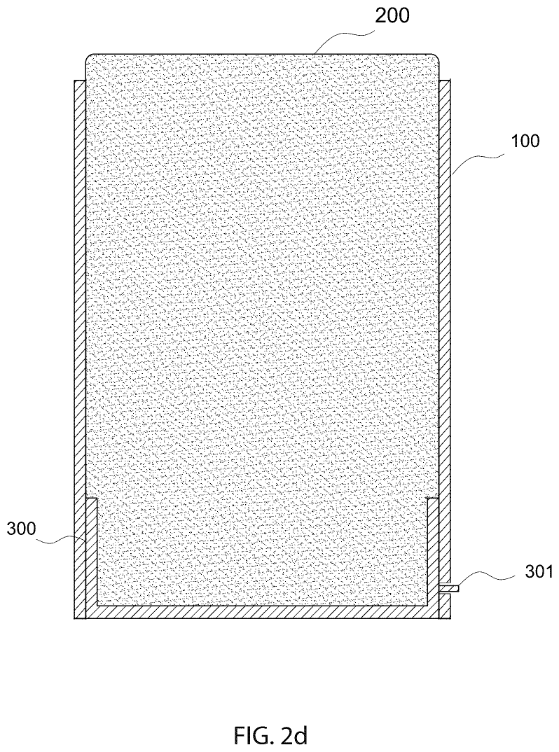

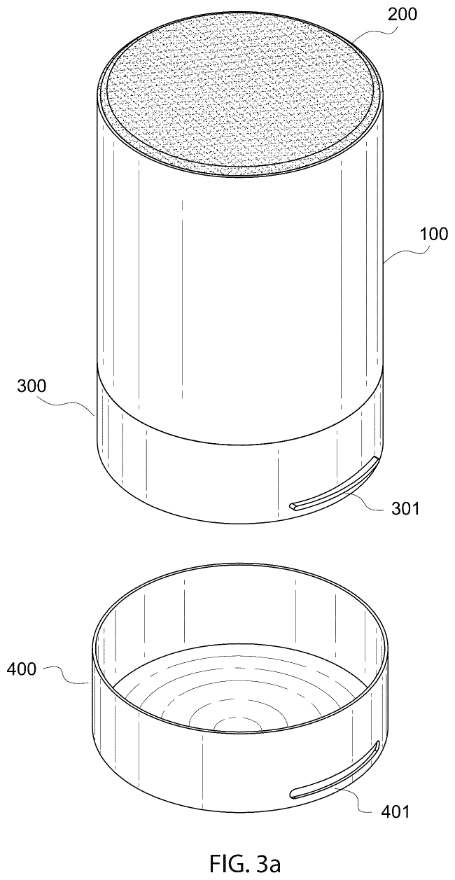

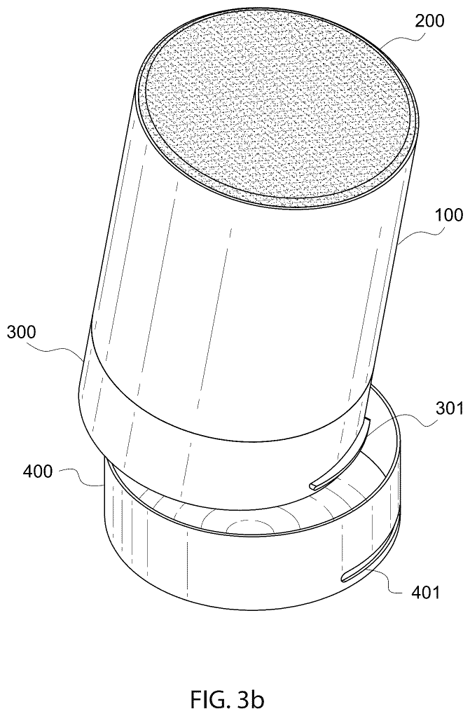

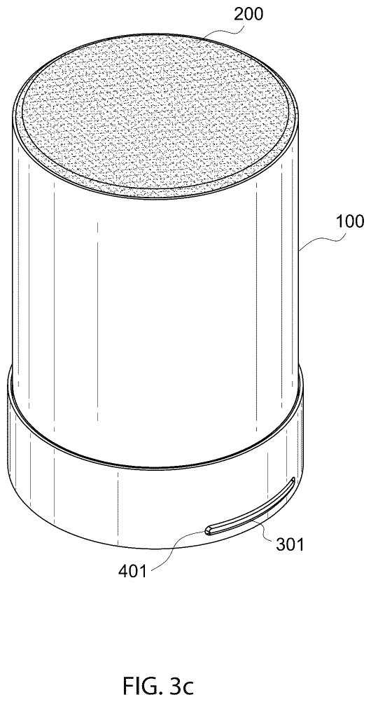

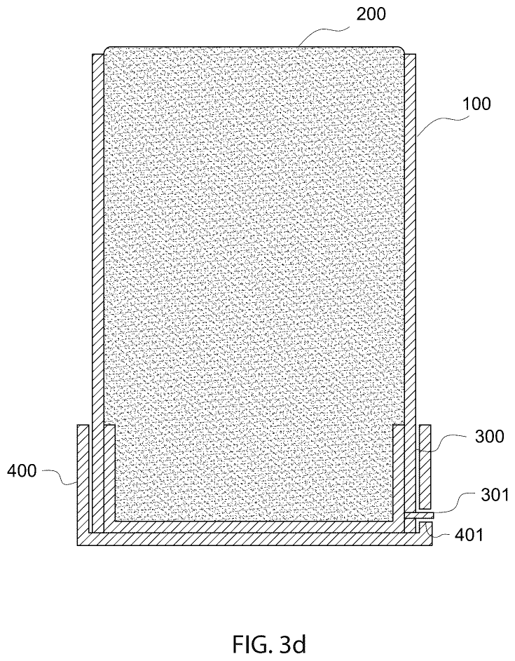

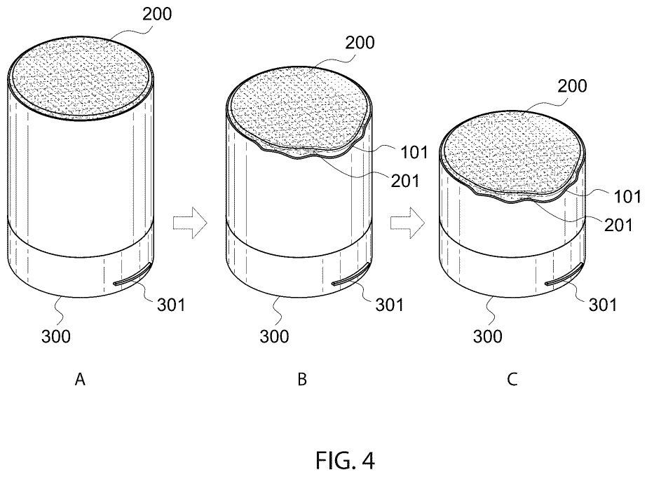

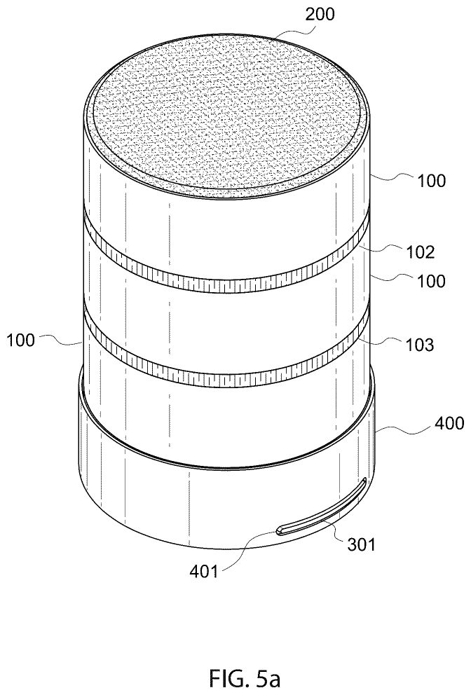

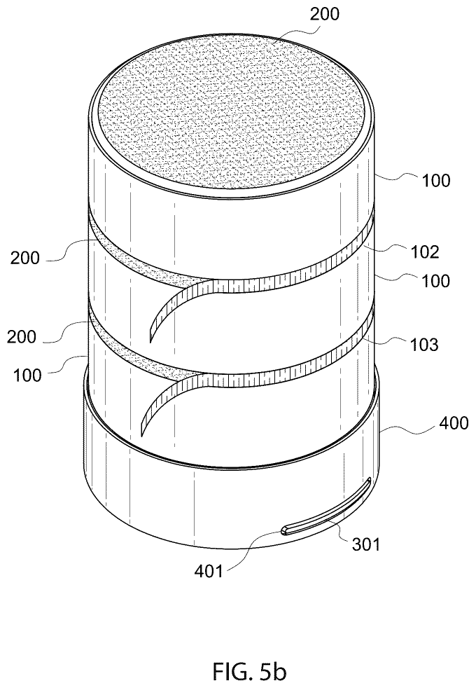

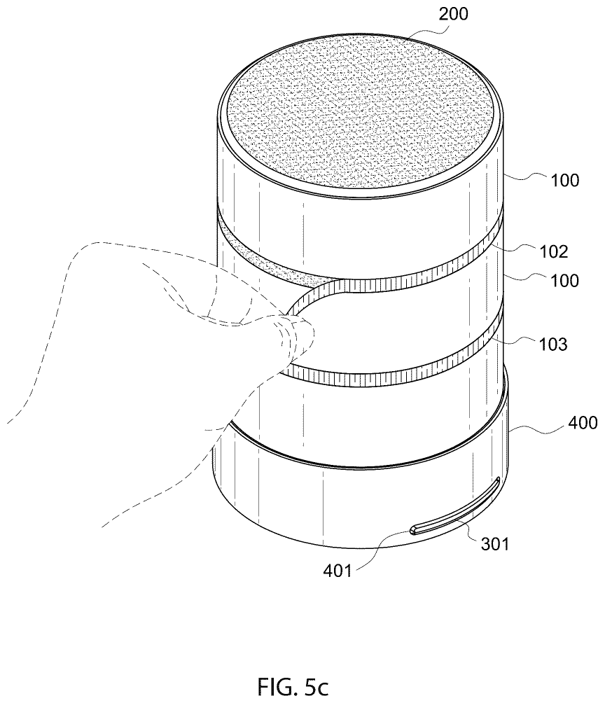

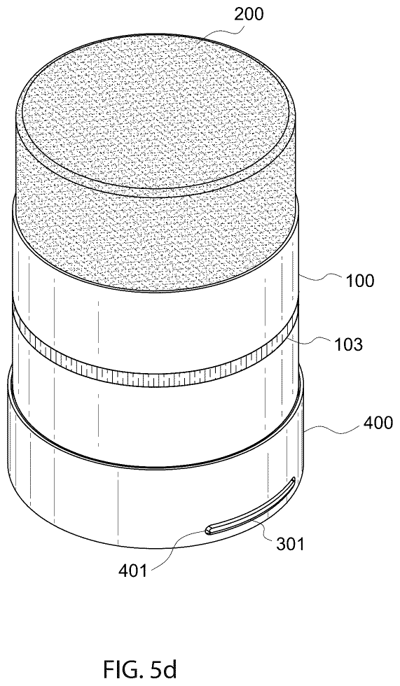

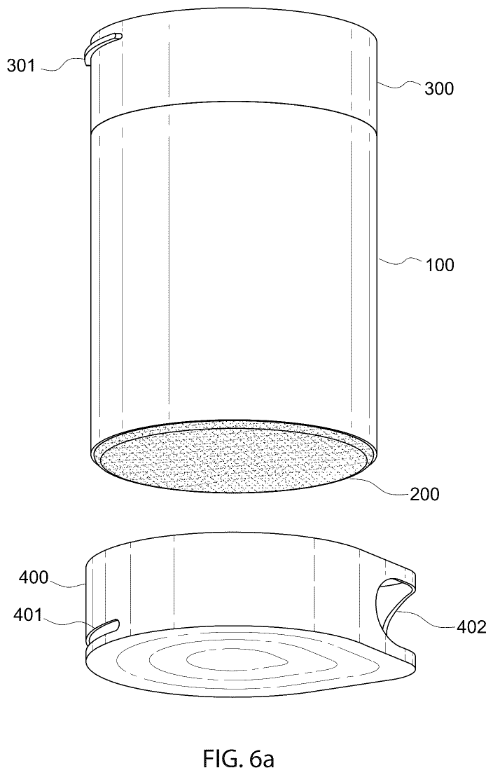

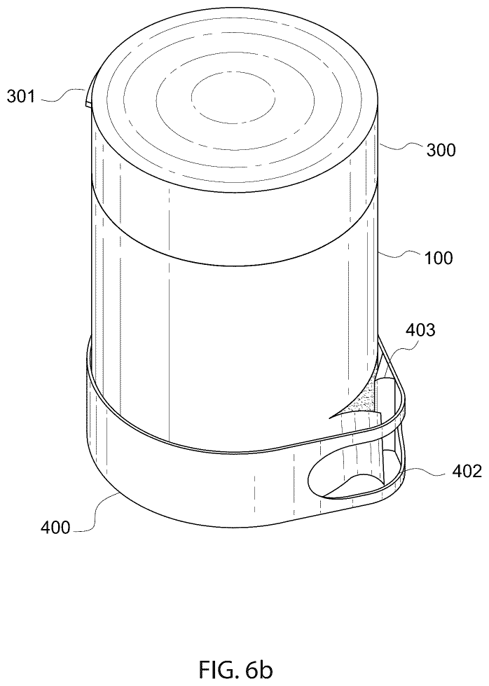

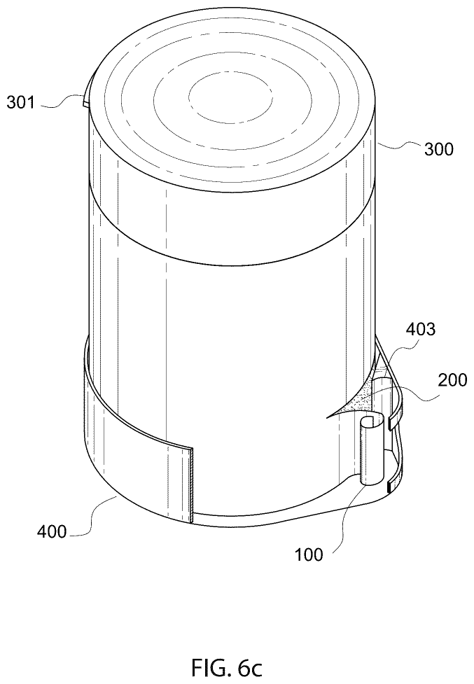

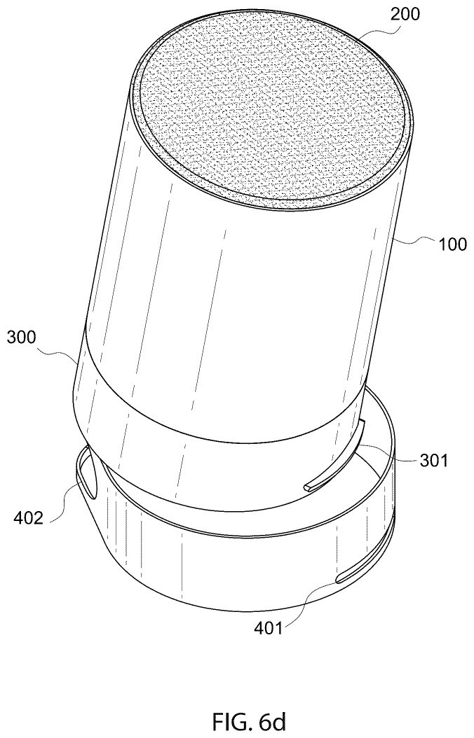

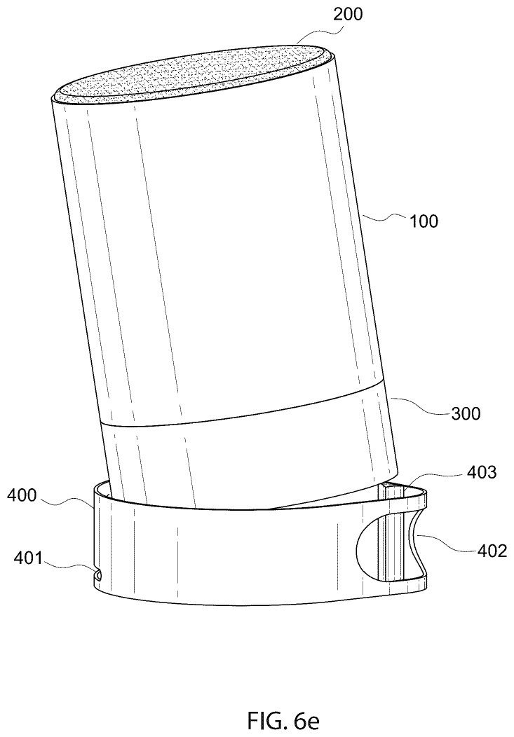

Referring to FIG. 1A, FIG. 1B, and FIG. 1C, a cosmetic product comprises a solid formulation (200) encapsulated by a removable, water-resistant coating (100). The coating leaves one face of the product exposed for use, as clearly shown in the cross-sectional view of FIG. 1B.

The solid formulation (200) may comprise various personal care products, including but not limited to hand soap, body wash, shampoo, conditioner, deodorant, or other cosmetic products. The formulation may be customized to include various active ingredients suitable for different functions.

In one embodiment, the coating (100) comprises a self-regulating material designed to degrade synchronously with product use. The coating may comprise various water-resistant materials safe for cosmetic use. For example, the coating may comprise natural waxes like beeswax and plant-based waxes, synthetic waxes, biodegradable polymers, or combinations thereof.

The self-regulating coating serves multiple purposes: a) It protects the product from premature degradation due to moisture and air exposure. b) It provides an improved grip for the user. c) It allows for controlled product use by exposing only a portion of the product at a time.

The self-regulating mechanism of the coating (100) functions through controlled degradation. As the exposed face of the solid formulation (200) wears away during use, the adjacent coating gradually loses structural support. This loss of support, combined with the coating's precisely calibrated composition, causes a section to break apart from the surrounding coating and separate from the formulation, revealing a fresh surface underneath. The degradation rate is engineered to align with the product's typical usage rate, ensuring the protective coating remains intact around the unused portion while consistently providing access to a fresh surface.

This mechanism is achieved through a carefully balanced combination of the coating's physical properties, including but not limited to its hardness, brittleness, and adhesion to the solid formulation. These properties can be adjusted based on the specific formulation and intended use of the product, allowing for customization across various cosmetic applications.

As illustrated in FIG. 4A through FIG. 4C, the self-regulating mechanism allows the protective coating to degrade in tandem with the product, retaining the protective and gripping characteristics of the coating for the entire usable life of the product.

The composition of the self-regulating coating may be adjusted to achieve the desired degradation rate. For example, the coating may comprise a blend of waxes with different melting points or may include additives that enhance water solubility at a certain threshold.

Referring to FIG. 2A and FIG. 2B, the invention includes a base protection system. This system comprises a base component (300) made of a durable material such as but not limited to wood, plastic, bio-polymers, or metal, onto which the formulation (200) is pressed or mounted. The base protects the bottom and edges of the solid formulation, which are most susceptible to impacts and water exposure. The wax coating (100) is then applied over the formulation and part of the base, as shown in the cross-sectional view of FIG. 2d.

The base (300) serves multiple functions: a) It provides additional protection against impacts and water ingress. b) It allows for the attachment of additional accessories, such as a cap (400) with a wax removal mechanism showing in FIG. 6a through 6e. c) It incorporates a mounting system (301) for attaching accessories as shown is FIG. 3a through 3d.

In another embodiment, illustrated in FIG. 5a through FIG. 5d, the coating is designed with an embedded cord system for easy removal. The coated product includes one or more cords (102, 103) embedded within or underneath the coating (100). These cords are positioned to allow for the removal of specific sections of the coating when pulled.

The cord may be made of any suitable material that is strong enough to cut through the wax coating when pulled, yet safe for cosmetic use. Materials may include, but are not limited to, cotton, nylon, or other synthetic fibers.

The cord system may be designed in various configurations: a) A single cord spiraling around the product, allowing for gradual removal of the coating as the product is used. b) Multiple cords positioned in parallel, each removing a strip of coating when pulled. c) A network of cords that can remove the coating in predetermined patterns or sections.

To use the cord removal system, the user simply grasps the exposed end of a cord and pulls it, causing it to cut through and remove a section of the coating. This exposes a fresh surface of the solid formulation underneath, as demonstrated in FIG. 5C and FIG. 5D.

Referring to FIG. 6A through FIG. 6E, the invention introduces a wax removal mechanism integrated into a complementary cap system (400). This mechanism offer yet another coating removal option to the previously described self-regulating and embedded cord systems, offering an alternative method for controlled exposure of the solid cosmetic formulation.

As illustrated in FIG. 6A, the cap (400) incorporates a mechanical wax removal system featuring a cutting structure (403). This structure is designed to precisely separate the wax coating from the solid product, providing users with enhanced control over product exposure. The cutting structure may comprise various configurations of blades, edges, or other separation systems, each optimized for efficient and controlled wax removal.

FIG. 6B demonstrates the engagement of the wax removal mechanism (403) when the product is inserted into the cap (400). This configuration allows users to remove portions of the wax coating as needed, while still benefiting from the protective function of the cap during storage or travel. The multifunctionality of this system is further enhanced by the inclusion of a wax ejection hole (402), which facilitates the disposal of removed wax material.

The internal workings of the wax removal mechanism are revealed in the cut-away view provided in FIG. 6C. This illustration shows how the rotation of the mechanism (403) effectively peels away a portion of the coating, exposing a fresh surface of the encased formulation (200). The removed wax is then channeled through the ejection hole (402), maintaining cleanliness and ease of use.

Alternative embodiments of this wax removal system may incorporate additional features to enhance functionality and user experience. These could include: a) A storage chamber for collecting removed wax, allowing for less frequent disposal. b) An adjustable depth setting mechanism to control the amount of coating removed, catering to different user preferences or product types. c) Various blade configurations or removal techniques to accommodate different coating materials or product shapes.

The integration of this wax removal mechanism with the base attachment system is demonstrated in FIG. 6D and FIG. 6E. The mounting tab (301) and female slot (401) mechanism not only secures the product within the cap but also ensures proper alignment with the wax removal mechanism. This design facilitates easy mounting and storage while maintaining accessibility to the wax removal function.

This wax removal mechanism not only complements the self-regulating and cord-based systems previously described but also provides a crucial solution for scenarios where self-regulation may not be achievable or optimal. The mechanical removal system is particularly valuable when:

a) The formulation is too soft to support effective self-regulation of the coating. b) The coating is designed for extreme durability or increased thickness, such as for travel products, where self-regulation may be impractical. c) Specific formulations require coating properties that are not conducive to self-regulation.
In these cases, manual removal via the integrated mechanism becomes more suitable, as it can be effectively achieved with a much wider range of coating compositions and thicknesses.

By providing precise control over wax removal across a broader spectrum of product types, this system significantly enhances the overall user experience and extends product lifespan even in challenging applications.

The versatility of this coating removal system allows for customization across various product types and user preferences, accommodating a wider range of formulations and use cases. This adaptability further exemplifies the innovation inherent in the protective coating system for solid cosmetic and hygiene products, ensuring that the benefits of the coating can be realized even when self-regulation is not feasible or desirable.

The invention provides several advantages: a) Extended product lifespan due to protection from moisture and air. b) Improved user experience through enhanced grip and controlled product use. c) Customization of coating properties for different product types. d) Environmentally friendly alternative to excessive packaging. e) Multiple options for coating removal to suit various user preferences and product types.

While the invention has been described with reference to specific embodiments, various modifications and alternatives are possible. These may include, but are not limited to: different coating materials, product shapes, scented or color-changing coatings, textured coatings for additional grip, biodegradable base and cap components, multiple product layers within a single formulation, and embedded active ingredients in the coating.

The scope of the invention is not limited to the described embodiments but is defined by the appended claims.

1) A system for protecting a hygiene product, comprising an enclosure formed by a water-resistant coating material, wherein the enclosure comprises: an interior surface configured to contact and receive the hygiene product, and an exterior surface for handling, wherein the coating material is configured to removably attach to the hygiene product, and wherein the enclosure enables exposure of at least a portion of the hygiene product from the interior surface while a user grips the exterior surface.

2) The system of claim 1, wherein the coating material is configured to be removed by at least one method selected from a group comprising: a) self-regulating degradation synchronous with use of the hygiene product, b) mechanical removal using a separating device, and c) an embedded cord system.

3) The system of claim 2, wherein the coating comprises a self-regulating material designed to degrade synchronously with use of the hygiene product.

4) The system of claim 2, further comprising a separating device for mechanical removal of the coating, the device comprising: a housing configured to accommodate the coated hygiene product; and a removal mechanism configured to remove a section of the coating, thereby exposing a fresh surface of the hygiene product.

5) The system of claim 4, wherein the removal mechanism comprises a blade positioned to scrape the coating as the coated hygiene product is moved relative to the housing.

6) The system of claim 4, further comprising a collection chamber for removed coating material.

7) The system of claim 4, further comprising an adjustable depth setting to control an amount of coating removed.

8) The system of claim 2, further comprising one or more cords embedded within or underneath the coating, wherein pulling a cord removes a section of the coating.

9) The system of claim 1, further comprising a base protection system attached to a bottom portion of the hygiene product.

10) A method for using a hygiene product protection system, the method comprising: providing a hygiene product at least partially encapsulated by a removable, water-resistant coating, wherein the coating forms an enclosure with an interior surface contacting the hygiene product and an exterior surface for handling; exposing a portion of the hygiene product for use; using the exposed portion of the hygiene product; and removing a section of the coating to expose a fresh portion of the hygiene product.
